(19) United States
(12) Patent Application Publication
(10) Pub. No.: US 2026/0261086 A1
(43) Pub. Date: Sep. 3, 2026

(54) CONNECTOR ASSEMBLY

(71) Applicant: Amphenol Corporation, Wallingford, CT (US)

(72) Inventors: Paul Horton Adams, Monroe, CT (US); Michael Edward Uppleger, Marine City, MI (US)

(21) Appl. No.: 19/455,314

(22) Filed: Jan. 21, 2026

Related U.S. Application Data
(60) Provisional application No. 63/766,154, filed on Mar. 3, 2025.

(51) Int. Cl. H01R 24/86; H01R 13/10; H01R 13/502; H01R 13/58; H01R 13/62; H01R 13/623; H01R 107/00

(52) U.S. Cl. CPC H01R 24/86; H01R 13/10; H01R 13/502; H01R 13/5825; H01R 13/6205; H01R 13/623; H01R 2107/00

(57) ABSTRACT

A connector assembly includes a first coupling structure, a second coupling structure on a rear side of the first coupling structure, a cable compression structure between the first coupling structure and the second coupling structure, and a biasing structure configured to bias the second coupling structure towards the first coupling structure.

### CROSS-REFERENCE TO RELATED APPLICATIONS

The present application claims priority to U.S. Provisional Patent Application No. 63/766,154 filed Mar. 3, 2025, the contents of which are hereby incorporated by reference in its entirety.

### TECHNICAL FIELD

The present disclosure relates to a connector assembly.

### BACKGROUND

Connector assemblies may experience harsh environments such as forces, vibrations, and/or stresses during use. Connector assemblies that are resilient against such forces and/or stresses is desirable.

### SUMMARY

In accordance with a non-limiting example, a connector assembly comprises a first coupling structure, a second coupling structure on a rear side of the first coupling structure, a cable compression structure between the first coupling structure and the second coupling structure, and a biasing structure configured to bias the second coupling structure towards the first coupling structure.

In addition to one or more of the features described herein, the first coupling structure includes a tapered annular wall configured to receive an elastic portion of the cable gland.

In addition to one or more of the features described herein, the tapered annular wall is configured to press the elastic portion radially inward when the elastic portion is received within the tapered annular wall.

In addition to one or more of the features described herein, the cable compression structure is a cable gland.

In addition to one or more of the features described herein, the biasing structure comprises a first magnet disposed on the first coupling structure and a second magnet disposed on the second coupling structure.

In addition to one or more of the features described herein, each of the first magnet and the second magnet is structured as an annular ring.

In addition to one or more of the features described herein, each of the first magnet and the second magnet is structured as a segmented magnet.

In addition to one or more of the features described herein, the first magnet and the second magnet may be rotated relative to each other to be axially aligned in an engaged configuration of the connector assembly and not axially aligned in a disengaged configuration of the connector assembly.

In addition to one or more of the features described herein, the biasing structure is a ratchet mechanism.

In addition to one or more of the features described herein, the ratchet mechanism is incorporated into the second coupling structure.

In addition to one or more of the features described herein, the cable compression structure comprises a plurality of fingers arranged in a circular pattern.

In addition to one or more of the features described herein, the cable compression structure comprises a plurality of finger modules, and wherein each of the finger modules comprises a plurality of fingers arranged in a circular pattern.

In addition to one or more of the features described herein, the first coupling structure includes a plurality of tapered annular walls, each of the tapered annular walls being configured to receive fingers of one of the finger modules.

In addition to one or more of the features described herein, a first ramp is formed on the first coupling structure, and a second ramp is formed on the second coupling structure.

In addition to one or more of the features described herein, the second coupling structure may be rotated with respect to the first coupling structure such that the second ramp pushes against the first ramp to move the second magnet away from the first magnet.

In addition to one or more of the features described herein, the first coupling structure comprises a connector insert.

In addition to one or more of the features described herein, the first coupling structure comprises a first coupling nut, and the second coupling structure comprises a second coupling nut.

In addition to one or more of the features described herein, the second coupling nut defines a wrench flat on an outer surface thereof.

In addition to one or more of the features described herein, the first coupling structure comprises a ramp collar, and the first ramp is formed on a rear edge of the ramp collar.

In addition to one or more of the features described herein, one or more cables is disposed through the second coupling structure and the cable gland.

In addition to one or more of the features described herein, the biasing structure comprises a magnet disposed on the first coupling structure or the second coupling structure.

The above features and advantages, and other features and advantages of the disclosure are readily apparent from the following detailed description when taken in connection with the accompanying drawings.

### BRIEF DESCRIPTION OF THE DRAWINGS

FIG. 1 shows a front perspective view of a connector assembly according to one or more embodiments;

FIG. 2 shows a rear perspective view of the connector assembly shown in FIG. 1;

FIG. 3 shows a front view of the connector assembly shown in FIG. 1;

FIG. 4 shows a cross-sectional view indicated by line 4-4 in FIG. 3;

FIG. 5 shows a side view of a connector assembly in a first configuration according to one or more embodiments;

FIG. 6 shows the connector assembly of FIG. 5 in a second configuration;

FIG. 7 shows a front perspective view of a connector assembly according to one or more embodiments;

FIG. 8 shows a front perspective view of a connector assembly according to one or more embodiments;

FIG. 9 shows a rear perspective view of the connector assembly of FIG. 8;

FIG. 10 shows a cross-sectional view indicated by line 10-10 in FIG. 9;

FIG. 11 shows a close-up view of a portion indicated by circle 11 in FIG. 10;

FIG. 12 shows a front perspective view of a connector assembly according to one or more embodiments;

FIG. 13 shows a side view of the connector assembly of FIG. 12;

FIG. 14 shows a rear perspective view of a connector assembly according to one or more embodiments;

FIG. 15 shows a front perspective view of the connector assembly of FIG. 14; and

FIG. 16 shows a side view of a connector assembly according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

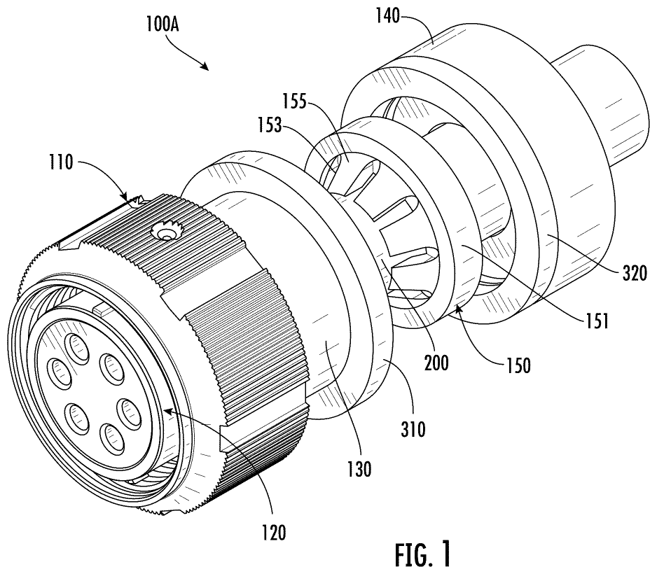

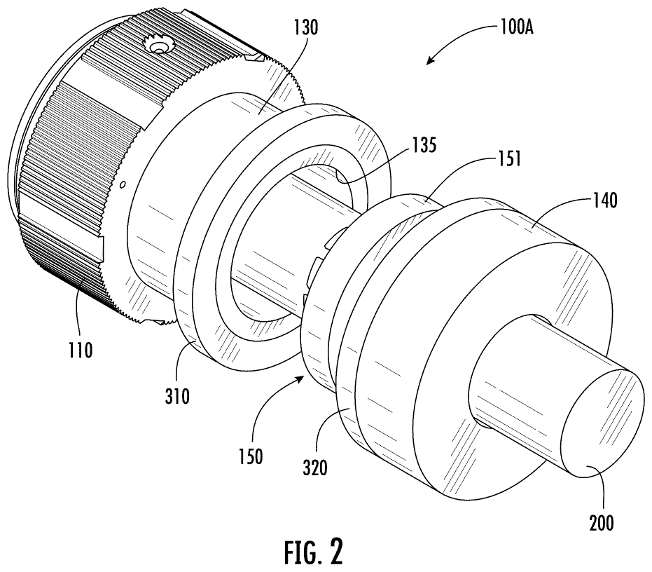

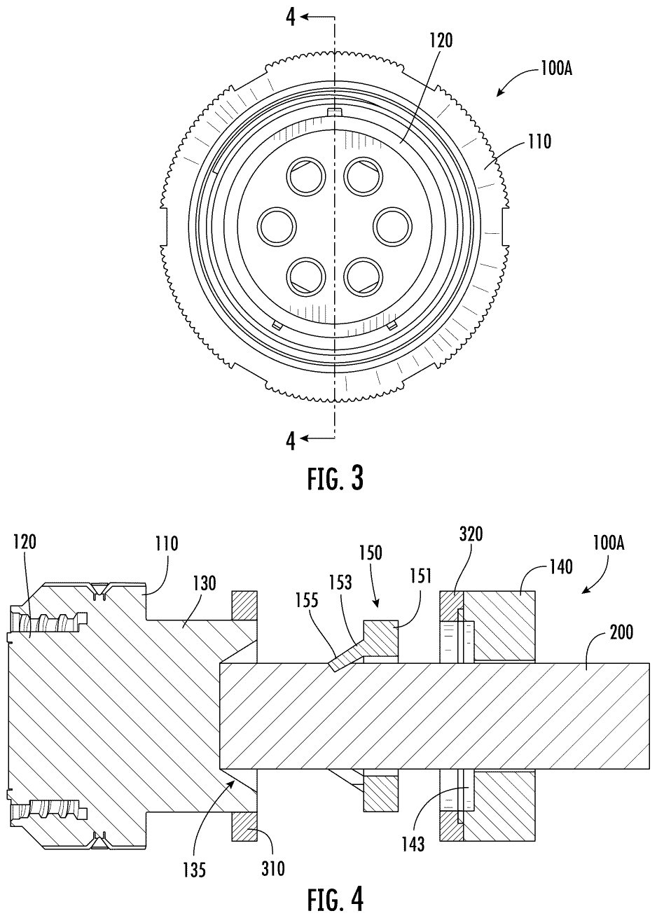

A connector assembly 100A according to one or more embodiments is shown in FIGS. 1-6. The connector assembly 100A includes a first coupling nut 110, a connector shell 120 within the first coupling nut 110, and a connector insert 130 on a rear of the first coupling nut 110. While FIG. 4 shows the first coupling nut 110, the connector shell 120, and the connector insert 130 being an integrated structure, according to one or more embodiments, the first coupling nut 110, the connector shell 120, and the connector insert 130 are separate structures. The first coupling nut 110 may include threading on an inner annular surface thereof for coupling with an outer surface of a corresponding threaded annular structure (not shown). The first coupling nut 110 may include a ratcheting mechanism. Examples of a ratcheting mechanism may be found, for example, in U.S. Pat. Nos. 7,914,311 and 11,955,748, the contents of which are hereby incorporated by reference in their entirety. The ratchet mechanism may be disposed between the first coupling nut 110 and the connector insert 130. The ratcheting mechanism may be replaced with a pair of magnets or a metal plate and a magnet.

An outer surface of the first coupling nut 110 may include a ridged structure for gripping. The connector assembly 100A may further include a second coupling nut 140 on a rear side of the connector insert 130. A cable 200 may be inserted through at least a rear portion of the connector insert 130, and through the second coupling nut 140. A cable gland 150 may be disposed around the cable 200 between the connector insert 130 and the second coupling nut 140. The cable gland 150 may include a main body 151 that is a ring-shaped structure disposed around the cable 200, and a plurality of fingers 153 extending from the main body 151 towards the connector insert 130. Each of the fingers 153 may be wedge-shaped and may include an abutment surface 155 facing radially outward. The fingers 153 may increase in thickness from a front free end towards a rear end that is attached to the main body 151. The abutment surface 155 of each of the fingers 153 may form a predetermined angle with an axial direction of the connector assembly 100A. The fingers 153 may have a protrusion on the abutment surface 155. The fingers 153 may have a free end that has a sharp edge on bottom portion thereof for increased localized pressure on the cable 200. The cable gland 150 may be manufactured from injection molding with materials such as elastomers, thermoplastic, thermoplastic elastomer, thermoplastic polyurethane, or other elastic materials known in the art. The cable gland 150 may be formed of steel, stainless steel, or other elastic metals materials known in the art and may be produced by a metal fabrication process such as sampling. The cable gland 150 may be plated to improve corrosion resistance. The design and the geometry (thickness, sharpness, material, etc.) of the cable gland 150 may be modified to ensure the cable is held sufficiently for harsh environments. The cable gland 150 may be formed by 3-D printing.

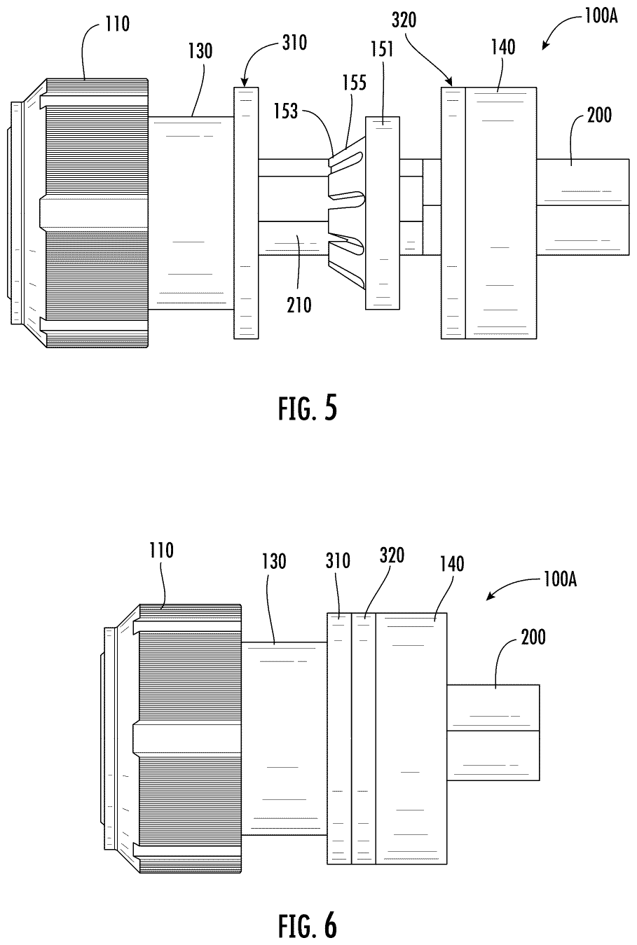

The connector insert 130 may include a tapered annular wall 135 defined at an inner surface of a rear portion of the connector insert 130. According to a non-limiting example, the tapered annular wall 135 may form an angle with the axial direction of the connector assembly 100A that is less than the predetermined angle formed by the fingers 153. Alternatively, the tapered annular wall 135 may form an angle with the axial direction of the connector assembly 100A that is equal to or greater than the predetermined angle formed by the fingers 153. The tapered annular wall 135 may comprise one angled surface, multiple angled surfaces with different angles, or a curved surface. When the cable gland 150 is inserted into the connector insert 130, the tapered annular wall 135 or the protrusion on the tapered annular wall 135 may abut the abutment surface 155 of each of the fingers 153 so as to press the fingers 153 radially inward, thereby clamping an outer surface of the cable 200. The cable 200 may be a single cable as shown in FIGS. 1-4 or may be a bundle of a plurality of cables 200 as shown in FIGS. 5-6. In the case of the bundle of the cables 200, a pressing force of the fingers 153 may press the cables 200 together. As shown in FIGS. 5 and 6, the connector assembly 100A may further include a cable sleeve 210 that holds the cables 200 together, and the cable gland 150 may be disposed around the cable sleeve 210. The connector assembly 100A may further include a first magnet 310 around a rear end of the connector insert 130 and a second magnet 320 on a front end of the second coupling nut 140. Alternatively, the first magnet 310 may be disposed on a rear edge of the connector insert 130 and/or the second magnet 320 may be disposed around a front end of the second coupling nut 140. As shown in FIG. 4, the second coupling nut 140 may include an annular recess 143. The second magnet 320 and/or the annular recess 143 may receive the main body 151 of the cable gland 150 therein as the second coupling nut 140 is moved towards the connector insert 130, and a front surface of the second coupling nut 140 may push the cable gland 150 towards the connector insert 130.

FIG. 5 shows the connector assembly 100A in a first configuration. The first magnet 310 and the second magnet 320 may have opposite polarities such that, when the second magnet 320 is brought closer to the first magnet 310, magnetic forces between the first magnet 310 and the second magnet 320 presses the second coupling nut 140 and the second magnet 320 onto the connector insert 130 and the first magnet 310. Thus, the forward surface of the second coupling nut 140 presses the cable glad 150 into the connector insert 130 such that the tapered annular wall 135 presses the fingers 153 radially inward and clamping the outer surface of the cable 200. When the first magnet 310 and the second magnet 320 are brought together by the magnetic forces, the connector assembly 100A is in a second configuration shown in FIG. 6. The second configuration may be a fully engaged configuration. According to one or more embodiments, only one of the first magnet 310 and the second magnet 320 may be employed, while the other may be replaced with a metal plate.

The second coupling nut 140 may define an inner bore having a diameter corresponding to an outer diameter of the cable 200 to have a snug and/or tight fit, and/or may have increased thickness to help straighten the cable 200 and allow for a tighter bend radius of the cable 200 as the cable 200 leaves the connector assembly 100A.

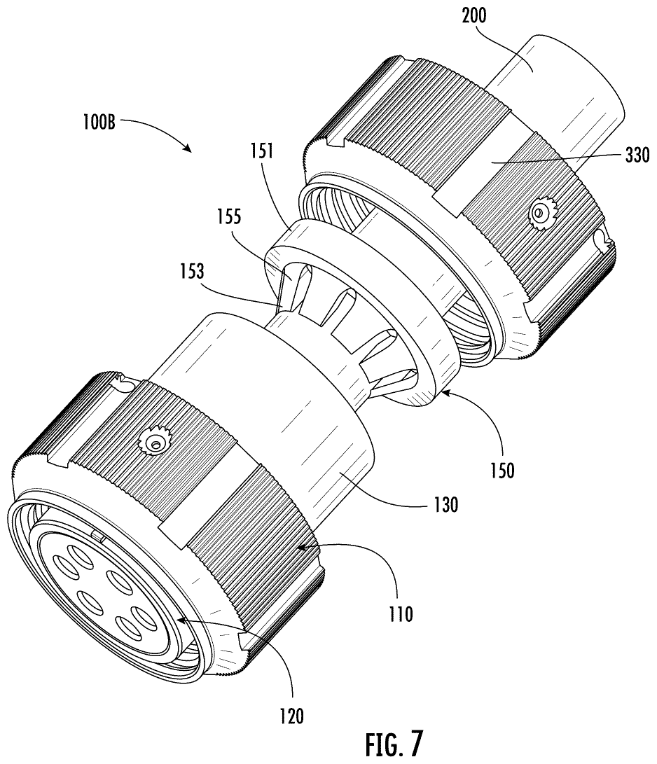

FIG. 7 shows a connector assembly 100B according to one or more embodiments. The connector assembly 100B is similar to the connector assembly 100A but includes a second coupling nut 330 having internal threading. The second coupling nut 330 may include a ratchet mechanism that is configured to be operated to press the fingers 153 of the cable gland 150 into the connector insert 130. The connector insert 130 may have external threading on an outer surface thereof that engages with the internal threading of the second coupling nut 330. The second coupling nut 330 with the ratchet mechanism may be employed instead of the first and second magnets 310, 320 as shown in FIG. 7 or, alternatively, may be employed together with the first and second magnets 310, 320. As described above, examples of a ratcheting mechanism may be found, for example, in U.S. Pat. Nos. 7,914,311 and 11,955,748. The ratcheting mechanism may be disposed between the connector insert 130 and the second coupling nut 330.

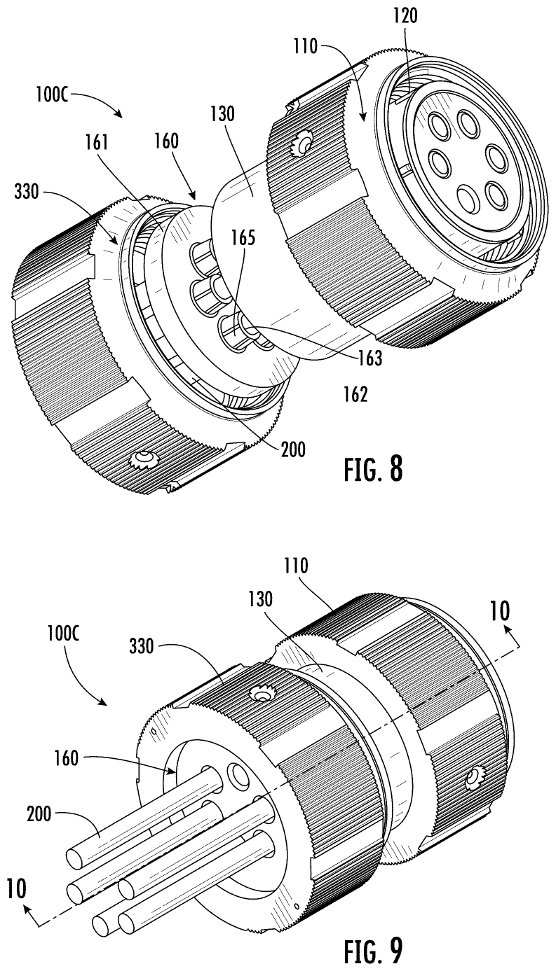

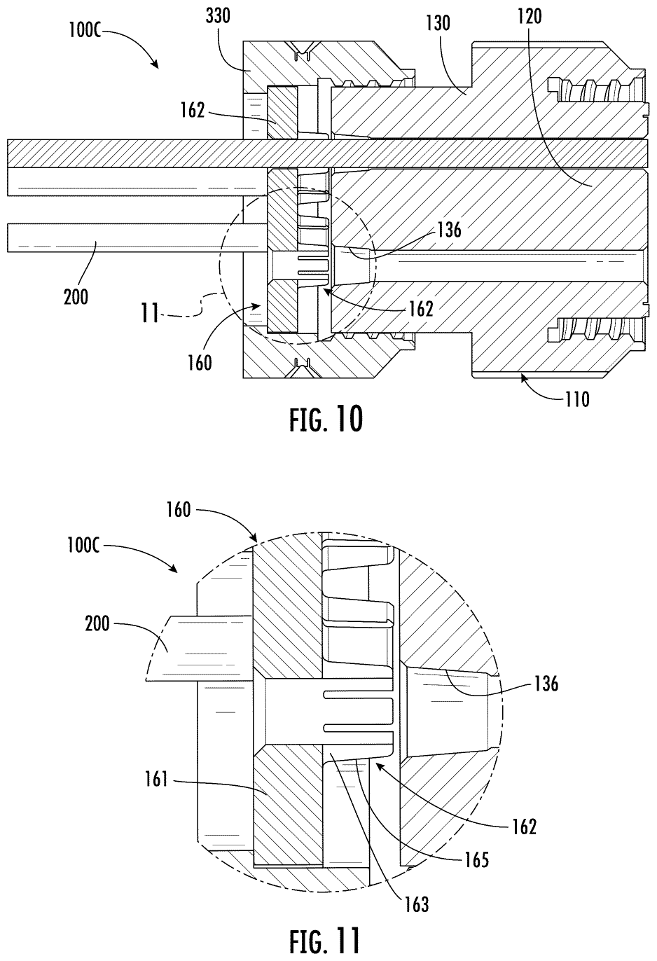

FIGS. 8-11 show a connector assembly 100C according to one or more embodiments. The connector assembly 100C may include a plurality of cables 200. The connector assembly 100C is similar to the connector assembly 100B but further includes a cable gland 160 having a plurality of finger modules 162 extending from a main body 161. Each of the finger modules 162 includes a plurality of fingers 163, with each of the fingers defining an abutment surface 165. While the cable gland 150 shown in FIGS. 1-7 has a single set of fingers 153 that extend in a circular pattern from the main body 151, the cable gland 160 shown in FIGS. 8-11 has a plurality of the finger modules 162, each of which has fingers 163 that extend in a circular pattern from the main body 161. Each of the fingers 163 of each of the finger modules 162 may form a predetermined angle with an axial direction of the connector assembly 100C. The connector insert 130 of the connector assembly 100C may include a plurality of tapered annular walls 136 defined in a rear portion of the connector insert 130. Each of the tapered annular walls 136 may form an angle with the axial direction of the connector assembly 100C that is less than the predetermined angle formed by the fingers 163. Alternatively, the tapered annular walls 136 may form angles with the axial direction of the connector assembly 100B that are equal to or greater than the predetermined angle formed by the fingers 163. Each of the tapered annular walls 136 may comprise one angled surface, multiple angled surfaces with different angles, or a curved surface. Thus, when the cable gland 160 is inserted into the connector insert 130, the tapered annular walls 136 abut the abutment surface 165 of each of the fingers 163 of each of the finger modules 162 so as to press the fingers 163 radially inward, thereby clamping an outer surface of each of the plurality of cables 200. The cable gland 160 may define inner bores having a diameter corresponding to an outer diameter of the cable 200 and/or may have increased thickness to help straighten the cable 200 and allow for a tighter bend radius of the cable 200 as the cable 200 leaves the connector assembly 100C. The cable gland 160 may be made of a flexible material to help seal the connector assembly 100C or rigid materials to align the cables 200.

While FIGS. 8-11 show the second coupling nut 330 with the ratcheting mechanism, the first magnet 310 and the second magnet 320 may be used instead of or in addition to the ratcheting mechanism. The cable gland 160 may be manufactured from injection molding with materials such as elastomers, thermoplastic, thermoplastic elastomer, thermoplastic polyurethane, or other elastic materials known in the art. The cable gland 160 may be formed of steel, stainless steel, or other elastic metals materials known in the art and may be produced by a metal fabrication process such as sampling. The cable gland 160 may be plated to improve corrosion resistance. The design and the geometry (thickness, sharpness, material, etc.) of the cable gland 160 may be modified to ensure the cable is held sufficiently for harsh environments. The cable gland 160 may be formed by 3-D printing.

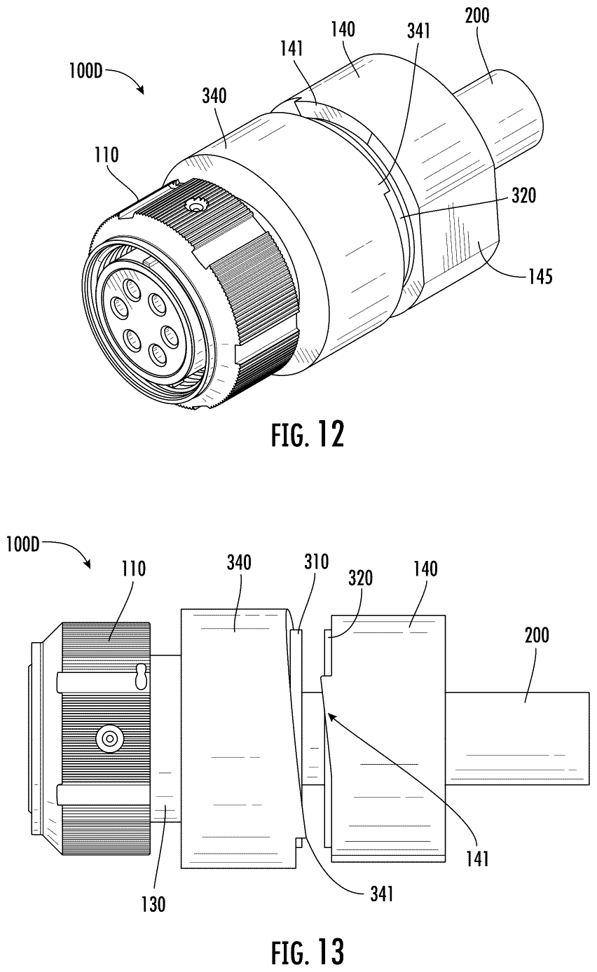

FIGS. 12-13 show a connector assembly 100D according to one or more embodiments. The connector assembly 100D is similar to the connector assembly 100A shown in FIGS. 1-6 but further includes a ramp collar 340 around the connector insert 130. The ramp collar 340 may be a separate structure from the connector insert 130 or may be integrally formed on the connector insert 130. The ramp collar 340 includes a first ramp 341 and the second coupling nut 140 includes a second ramp 141. In order to move the second magnet 320 away from the second magnet 310, the second coupling nut 140 may be rotated such that the second ramp 141 pushes against the first ramp 341 to move the second coupling nut 140 away from the ramp collar 340, thereby creating a gap between the second magnet 320 and the first magnet 310 and weakening the magnetic forces therebetween. Alternatively, the ramp collar 340 may be rotated with respect to the second coupling nut. With the weakened magnetic forces between the second magnet 320 and the first magnet 310, the second coupling nut 140 may be pulled away from the ramp collar 340. To assist in rotating the second coupling nut 140, a wrench flat 145 or a plurality of wrench flats 145 may be formed on an outer surface thereof. A wrench (not shown) may engage with the wrench flat(s) 145 to rotate the second coupling nut 140.

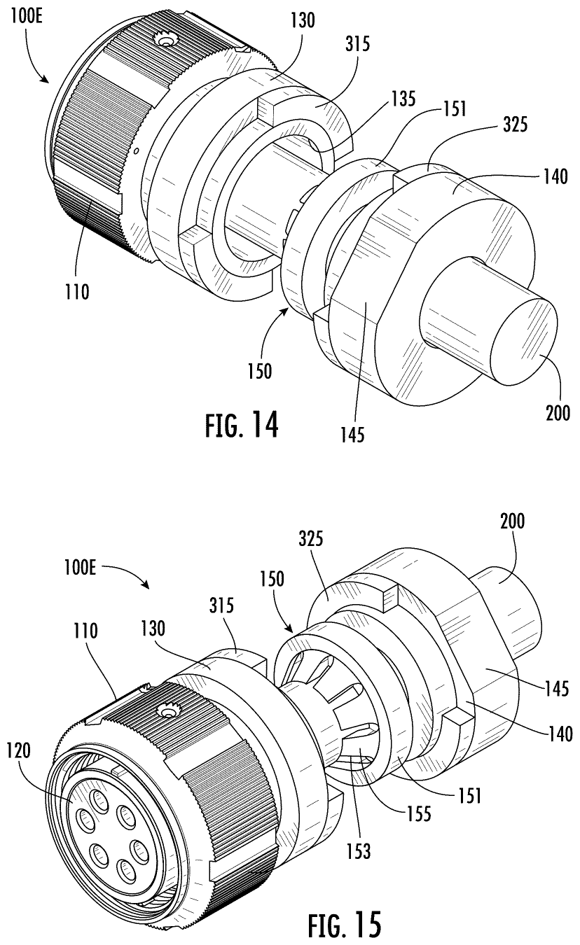

FIGS. 14-15 show a connector assembly 100E according to one or more embodiments. The connector assembly 100E is similar to the connector assembly 100A shown in FIGS. 1-6 but, instead of the first magnet 310 and the second magnet 320 that are structured as annular rings, the connector assembly 100E includes a first segmented magnet 315 on the connector insert 130 and a second segmented magnet 325 on the second coupling nut 140. To engage the connector assembly 100E, the second coupling nut 140 may be rotated to axially align the second segmented magnet 325 with the first segmented magnet 315 such that the magnetic forces therebetween pulls the second coupling nut 140 towards the connector insert 130. To disengage the connector assembly 100E, the second coupling nut 140 may be rotated to radially offset the second segmented magnet 325 from the first segmented magnet 315 such that the second segmented magnet 325 and the first segmented magnet 315 are not aligned (or minimally aligned) along the axial direction, thereby weakening the magnetic forces between the second segmented magnet 325 and the first segmented magnet 315. With the weakened magnetic forces between the second magnet 320 and the first magnet 310, the second coupling nut 140 may be pulled away from the connector insert 130. To assist in rotating the second coupling nut 140, a wrench flat 145 or a plurality of wrench flats 145 may be formed on an outer surface thereof. A wrench (not shown) may engage with the wrench flat(s) 145 to rotate the second coupling nut 140. According to one or more embodiments, only one of the first segmented magnet 315 and the second segmented magnet 325 may be employed, while the other may be replaced with a metal plate.

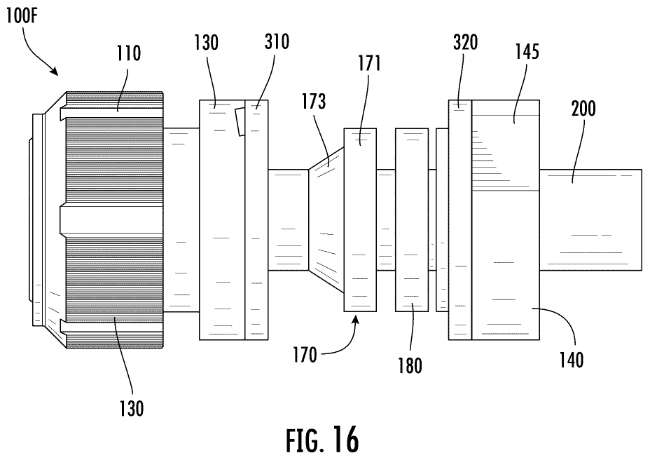

FIG. 16 shows a connector assembly 100F according to one or more embodiments. The connector assembly 100F includes a cable gland 170 that has a tapered outer wall 173. The tapered outer wall 173 may be elastic so as to deform inward when pressed by the tapered annular wall 135. The tapered outer wall 173 may have one or more protrusions on an upper surface thereof. The tapered outer wall 173 may have a free end that has a sharp edge on bottom portion thereof for increased localized pressure on the cable 200. The cable gland 170 may be manufactured from injection molding with materials such as elastomers, thermoplastic, thermoplastic elastomer, thermoplastic polyurethane, or other elastic materials known in the art. The cable gland 170 may be formed of steel, stainless steel, or other elastic metals materials known in the art and may be produced by a metal fabrication process such as sampling. The cable gland 170 may be plated to improve corrosion resistance. The design and the geometry (thickness, sharpness, material, etc.) of the cable gland 170 may be modified to ensure the cable is held sufficiently for harsh environments. The cable gland 170 may be formed by 3-D printing. The connector assembly 100F may further include a compression grommet 180. The compression grommet 180 may be structured to press against the cable gland 170 to enhance compression of the cable gland 170 as the first magnet 310 and the second magnet 320 are brought together. That is, the compression grommet 180 may be structured such that an appropriate amount of force is applied to the cable gland 170 when the first magnet 310 and the second magnet 320 are brought together. For example, the compression grommet 180 may be structured with an axial dimension and/or a material that transmits a desired amount of force to the cable gland 170. The compression grommet 180 may be rigid and define a bore therethrough having a diameter corresponding to an outer diameter of the cable 200 and/or may have increased thickness to help straighten the cable and allow for a tighter bend radius of the cable 200 as the cable 200 leaves the connector assembly 100F.

The first magnet 310, the second magnet 320, the first segmented magnet 315, and the second segmented magnet 325 may be neodymium magnets or electromagnets. The first magnet 310 and the second magnet 320, the first segmented magnet 315 and the second segmented magnet 325, and the ratcheting mechanism are examples of biasing structures. According to one or more embodiments, the second coupling nut 140 does not include any threading. According to one or more embodiments, the first coupling nut 110, the connector shell 120, the connector insert 130, and/or the ramp collar 340 is an example of a first coupling structure, and the second coupling nut 140, 330 is an example of a second coupling structure. According to one or more embodiments, the cable gland 150, 160, 170 may be formed of metal, plastic, polytetrafluoroethylene, or other materials known in the art. The cable gland 150, 160, 170 is an example of a cable compression structure. The fingers 153, 163 and the tapered outer wall 173 are examples of an elastic portion of the cable gland 150, 160, 170.

It was discovered that, when connector assemblies are threaded together for engagement, repeated use may loosen the threaded engagement over time. For example, vibrations may loosen the threaded engagement. It was discovered that such loosening can occur more frequently in high g-force applications. When the threaded engagement is loosened, cable glands may also loosen against the cables therein. A connector assembly 100A, 100B, 100C, 100D, 100E according to one or more embodiments may allow for engagement without reliance on threaded engagements that could loosen with repeated use. Thus, a connector assembly 100A, 100B, 100C, 100D, 100E according to one or more embodiments may be more resilient and less prone to unintentional disengagement. Additionally, a connector assembly 100A, 100B, 100C, 100D, 100E according to one or more embodiments may allow for simple engagement and disengagement.

The terms “a” and “an” do not denote a limitation of quantity, but rather denote the presence of at least one of the referenced items. The term “or” means “and/or” unless clearly indicated otherwise by context.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A connector assembly comprising:
a first coupling structure;
a second coupling structure on a rear side of the first coupling structure;
a cable compression structure between the first coupling structure and the second coupling structure; and
a biasing structure configured to bias the second coupling structure towards the first coupling structure.

2. The connector assembly of claim 1, wherein the first coupling structure includes a tapered annular wall configured to receive an elastic portion of the cable gland.

3. The connector assembly of claim 2, the tapered annular wall is configured to press the elastic portion radially inward when the elastic portion is received within the tapered annular wall.

4. The connector assembly of claim 1, wherein the cable compression structure is a cable gland.

5. The connector assembly of claim 1, wherein the biasing structure comprises a first magnet disposed on the first coupling structure and a second magnet disposed on the second coupling structure.

6. The connector assembly of claim 5, wherein each of the first magnet and the second magnet is structured as an annular ring.

7. The connector assembly of claim 5, wherein each of the first magnet and the second magnet is structured as a segmented magnet.

8. The connector assembly of claim 7, wherein the first magnet and the second magnet may be rotated relative to each other to be axially aligned in an engaged configuration of the connector assembly and not axially aligned in a disengaged configuration of the connector assembly.

9. The connector assembly of claim 1, wherein the biasing structure is a ratchet mechanism.

10. The connector assembly of claim 9, wherein the ratchet mechanism is incorporated into the second coupling structure.

11. The connector assembly of claim 1, wherein the cable compression structure comprises a plurality of fingers arranged in a circular pattern.

12. The connector assembly of claim 1, wherein the cable compression structure comprises a plurality of finger modules, and wherein each of the finger modules comprises a plurality of fingers arranged in a circular pattern.

13. The connector assembly of claim 12, wherein the first coupling structure includes a plurality of tapered annular walls, each of the tapered annular walls being configured to receive fingers of one of the finger modules.

14. The connector assembly of claim 5, wherein a first ramp is formed on the first coupling structure, and a second ramp is formed on the second coupling structure.

15. The connector assembly of claim 14, wherein the second coupling structure may be rotated with respect to the first coupling structure such that the second ramp pushes against the first ramp to move the second magnet away from the first magnet.

16. The connector assembly of claim 1, wherein the first coupling structure comprises a connector insert.

17. The connector assembly of claim 1, wherein the first coupling structure comprises a first coupling nut, and the second coupling structure comprises a second coupling nut.

18. The connector assembly of claim 17, wherein the second coupling nut defines a wrench flat on an outer surface thereof.

19. The connector assembly of claim 14, wherein the first coupling structure comprises a ramp collar, and the first ramp is formed on a rear edge of the ramp collar.

20. The connector assembly of claim 1, wherein one or more cables is disposed through the second coupling structure and the cable gland.

21. The connector assembly of claim 1, wherein the biasing structure comprises a magnet disposed on the first coupling structure or the second coupling structure.
